(19) United States
(12) Patent Application Publication
(10) Pub. No.: US 2008/0305183 A1
(43) Pub. Date: Dec. 11, 2008

(54) PROCESS FOR ELIMINATING BACTERIAL SPORES ON SURFACES AND SPORICIDE FOR USE IN THE PROCESS

(75) Inventors: Vincent Brian Croud, Sudbury (GB); Philip James Weaver, Bures (GB); Mark Wallace Squire, Newmarket (GB); Kelly Ann Ames, Sudbury (GB)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington, DE (US)

(21) Appl. No.: 12/134,340

(22) Filed: Jun. 6, 2008

Related U.S. Application Data
(60) Provisional application No. 60/933,731, filed on Jun. 8, 2007.

(51) Int. Cl. A01N 59/00; A01P 1/00

(52) U.S. Cl. 424/616

(57) ABSTRACT

A process for eliminating bacterial spores on surfaces by contacting the surfaces with an aqueous composition comprising 3 to 30 wt. % of hydrogen peroxide and having a pH value of 6 to 8 for a period of 1 to 60 minutes at a temperature of 0 to 35° C., wherein the process does not comprise any germination step.

### FIELD OF THE INVENTION

The invention relates to a process for eliminating bacterial spores on surfaces by contacting the surfaces with an aqueous composition of pH 6 to 8 comprising hydrogen peroxide.

### BACKGROUND OF THE INVENTION

Bacterial spores are a health risk. They can cause serious problems in various areas, for example, food poisoning and food spoilage in the food industry or hospital acquired infections, to name only two problems.

It is known from JP-A-61015672 to eliminate bacterial spores by germinating the spores through a germination-promoting treatment and killing the so-formed vegetative form of the bacteria with hydrogen peroxide. Germination-promoting substances include glucose (dextrose), adenosine, enzymes and primary alpha-amino acids, such as L-alanine.

### SUMMARY OF THE INVENTION

It has now been found that it is possible to eliminate bacterial spores on surfaces by a process which comprises contacting a surface with an aqueous composition comprising hydrogen peroxide and having a pH value in the range of 6 to 8 without carrying out any germination step, such as, for example, carrying out a germination-promoting treatment. Depending on ambient conditions the spore form may be largely present in the environment, rather than the vegetative form. Bacterial spores are much tougher to kill than the vegetative form of the bacteria.

Accordingly, the present invention is related to a process for eliminating bacterial spores on surface by a process which comprises contacting a surface with an aqueous composition comprising 3 to 30 wt. %, preferably 5 to 25 wt. %, most preferably 5 to 20 wt. %, in particular 10 to 20 wt. % of hydrogen peroxide and having a pH value of 6 to 8, preferably of 6.5 to 7.5 (hereinafter for brevity purposes also called “aqueous composition”) for a period of 1 to 60 minutes, preferably 5 to 30 minutes, most preferably 15 to 30 minutes at a temperature of 0 to 35° C., preferably 15 to 25° C., wherein the process does not comprise any germination step.

### DETAILED DESCRIPTION OF THE INVENTION

The present invention provides a process for eliminating bacterial spores on a surface comprising contacting the surface with an aqueous composition comprising hydrogen peroxide and having a pH value in the range of 6 to 8. The process does not comprise any germination step, neither prior to nor during the contact of the surfaces with the aqueous composition. In other words, the process according to the invention does not comprise any deliberate exposure of the bacterial spores to germination-promoting conditions or treatment of the surfaces with germination-promoting substances like, for example, amino acids or monosaccharides. Surprisingly, the process according to the invention provides the ability to eliminate bacterial spores on surfaces at a sufficient kill rate without carrying out any germination step or germination-promoting treatment. Rather, it is sufficient to contact the surfaces with the aqueous composition for a period of 1 to 60 minutes at a temperature of 0 to 35° C.

The process according to the invention can be carried out under extreme conditions, i.e., use of an aqueous composition with high hydrogen peroxide content at high temperature (near the upper end of the temperature range of 0 to 35° C.) at a long contact time (near the upper end of the time period range of 1 to 60 minutes). However, this is not necessary and the skilled person will select the process conditions accordingly. For example, if the temperature conditions are low it is expedient to select a long contact time and/or an aqueous composition with high hydrogen peroxide content; similar considerations apply in case contact time is short or hydrogen peroxide concentration is low.

In the process according to the invention bacterial spores are killed on surfaces. The surface may be or comprise a porous surface; however, preferably the surface is a so-called “hard” surfaces, i.e., a non-porous, non-soaking surface. The surface may comprise various materials. Preferably, the surface is selected from the group consisting of wood, wood-based materials, plastics, ceramics, glass, concrete, metals and metal alloys. Metals and metal alloys include aluminum and steel, including stainless steel. The surface may be coated or not. The surface may be, for example, the surface of a substrate selected from the group consisting of floors, walls, ceilings, tiles, mirrors, windows, doors, door handles, handrails, furniture, equipment, apparatus housings and bed frames. The process is particularly useful for treating surfaces wherein the surface is the surface of a substrate in an area selected from the group consisting of food processing areas, doctors' offices, hospitals, surgical areas and nursing home areas.

Bacterial spores are the dormant spore forms of spore-forming bacteria, like bacillus and clostridium genera. It is advantageous that the process according to the invention allows for the elimination of bacterial spores on surfaces even in case of bacterial spores of pronounced resistance that are hard to eradicate, such as, in particular, bacillus subtilis, bacillus cereus, clostridium sporogenes and clostridium difficile. Whereas the spores of said bacilli are particularly problematic in food processing and food handling, the spores of clostridium difficile are a common cause for hospital-acquired infections. Although the sporicidal action is the essential effect of the process according to the invention, it shall be mentioned, that, when the process according to the invention is carried out, a disinfection of the surface is achieved in terms of elimination of the vegetative form of spore-forming bacteria and non-spore-forming bacteria including mycobacteria, fungi and viruses.

The aqueous compositions used in the process according to the invention for contacting the surfaces have a remarkable sporicidal efficacy although their pH value does not exceed 8. They allow for an at least a decimal log (lg) reduction in viable counts of 4 (equivalent to an at least 99.99% of kill rate) carried out, for example, according to European Standard EN 14347:2005, Clauses 4 and 5.

Thus, the invention also relates to sporicides in the form of the aqueous compositions comprising 3 to 30 wt. %, preferably 5 to 25 wt. %, most preferably 5 to 20 wt. %, in particular 10 to 20 wt. % of hydrogen peroxide and having a pH value of 6 to 8, preferably of 6.5 to 7.5.

Aqueous compositions comprising hydrogen peroxide and having neutral to alkaline pH values and methods for their preparation are disclosed, for example, in WO 96/01309 and WO 96/01310. It is advantageous that the aqueous compositions which are used in the process according to the invention have a pH value of 6 to 8 which is near to neutral or even neutral, because it allows for careful treatment of surfaces that are prone to attack such as corrosion or other damage by hydrogen peroxide compositions having stronger acidic or basic pH values.

Material compatibility is not the only advantage of the aqueous compositions. The aqueous compositions are environmentally friendly. The sporicide is essentially free of alcohol or other organic solvent. The compositions also can be prepared to have a useful shelf life of, for example, 24 months and more.

The aqueous compositions can be prepared by adjusting the pH value of an aqueous solution of hydrogen peroxide to the desired value, i.e., to a pH value of 6 to 8, preferably of 6.5 to 7.5, by adding an appropriate amount of at least one base and, optionally, by dilution to the desired hydrogen peroxide concentration with water, preferably deionized or distilled water. Adjustment of the pH value can be controlled making use of a conventional pH meter.

Aqueous solutions of hydrogen peroxide are commercially available; typically they comprise 15 to 50 wt. %, in general 15 to 35 wt. % of hydrogen peroxide and have an acidic pH value in the range of 1 to 3.5.

Examples of bases that can be used for the pH adjustment are alkali silicates, alkali carbonates, in particular however, alkali hydroxides such as lithium hydroxide, sodium hydroxide and potassium hydroxide. It is preferred to use aqueous solutions of the bases. If a dilution to the desired hydrogen peroxide concentration with water is carried out, this can be performed prior to, during, or after the pH adjustment.

Apart from hydrogen peroxide, water and base the aqueous compositions may comprise at least one auxiliary additive in a total proportion of, for example, 0 to 15, preferably 0.05 to 5 wt. %. Examples comprise anionic, amphoteric and, in particular, nonionic surfactants like polyethoxylated alcohols; hard water sequestrants; corrosion inhibitors; viscosity modifiers; fragrances; dyes; and, in particular, peroxide decomposition stabilizers such as transition metal sequestering (complexing, chelating) agents.

Examples of transition metal sequestering agents comprise compounds having nitrogen donors as ligands, such as dimethylglyoxime, triazacycloalkane compounds, especially 1,4,7-triazacyclononanes (TACNs) or dipyridylamine (DPA); carboxylic acid derivatives such as ethylenediamine-N,N,N′,N′-tetraacetic acid (EDTA) and its alkali salts, diethylenetriamine-N,N,N′,N′,N″-pentaacetic acid (DTPA) and its alkali salts, nitrilo-2,2′,2″-triacetic acid (NTA) and its alkali salts; phosphonic acid derivatives such as 1,2-diaminocyclohexyl tetra(methylene phosphonic acid) and its alkali salts, diethylene triamine penta(methylene phosphonic acid) and its alkali salts, ethylene diamine tetra(methylene phosphonic acid) and its alkali salts.

The aqueous compositions do not comprise any cationic surfactants or positively charged phase-transfer agents such as phosphonium salts, sulphonium salts or ammonium salts like quaternary ammonium salts.

Preferred aqueous compositions comprise as auxiliary additive(s) at least one transition metal sequestering agent and, optionally, at least one nonionic surfactant.

The preferred aqueous compositions have a composition as follows:

3 to 30 wt. %, preferably 5 to 25 wt. %, most preferably 5 to 20 wt. %, in particular 10 to 20 wt. % of hydrogen peroxide,

0.05 to 0.5 wt. % of alkali hydroxide,

0.005 to 1 wt. % of at least one transition metal sequestering agent,

0 to 10 wt. %, preferably 0.1 to 1 wt. % of at least one nonionic surfactant,

0 to 10 wt. %, preferably 0 wt. %, of at least one further auxiliary additive selected from the group consisting of anionic and amphoteric surfactants; hard water sequestrants; corrosion inhibitors; viscosity modifiers; fragrances and dyes; and

the wt. % proportion remaining is water to make 100 wt. %.

The preferred aqueous compositions may be prepared by mixing an aqueous solution of hydrogen peroxide with the remaining constituents, wherein the remaining constituents may take the form of aqueous preparations or aqueous solutions. It is expedient when the aqueous solution of the hydrogen peroxide as well as the remaining constituents potentially or actually comprising impurities in the form of traces of transition metal compounds, like transition metal salts, comprise at least one transition metal sequestering agent.

Not least for reasons of user's convenience and reproducibility it is preferred to supply the user (the person practising the process according to the invention) with the aqueous compositions in the form of a one-component ready-to-use product, i.e., a product that can be directly used in the process according to the invention for contacting the surfaces. However, it is also possible to supply the user with an aqueous concentrate of the aqueous compositions. Such aqueous concentrates are also in the form of a one component composition which can be used at the users' premises for the preparation of the aqueous compositions. To that end, the user only needs to dilute the aqueous concentrate with water, preferably deionized or distilled water, in the desired and appropriate mixing ratio.

In case the application of the aqueous composition to the surfaces shall be performed by wiping it is also possible to supply the user with wipes impregnated with the aqueous composition.

In the process according to the invention the surfaces are contacted with the aqueous compositions for 1 to 60 minutes, preferably 5 to 30 minutes, most preferably 15 to 30 minutes. Of course, the contact period may last longer but a contact period of 1 to 60 minutes, preferably 5 to 30 minutes, most preferably 15 to 30 minutes is sufficient to achieve the sporicidal effect of the process according to the invention.

The contacting step between the surface and the aqueous composition may be made by application of the latter by various application methods which are selected inter alia depending on the kind of substrate on which surface bacterial spores are to be killed/eliminated. Application methods for contacting the surface include and may be selected from the group consisting of wiping, brushing, dipping, rinsing and spraying. Typing the application method for contacting is spraying.

Depending on the application method employed, the application may be performed repeatedly in order to ensure the required contact time. In certain cases the application of the aqueous composition may be followed by a rinse with sterile water after the aqueous composition has taken its sporicidal effect; however, generally this is not the case and the surfaces are left to dry in the air at temperatures of 0 to 35° C. after the aqueous composition has been applied.

### EXAMPLES

Pbw means parts by weight.

### Example 1

### Preparation of a Sporicide with pH 7

A mixture of 40 pbw distilled water, 0.5 pbw Caflon DE-0600 from Univar Ltd. (nonionic surfactant, ethoxylated isodecanol), 0.3 pbw Dequest® 2066 from Univar Ltd. (=0.075 pbw sodium diethylene triamine penta(methylene phosphonate)) and 42.9 pbw of hydrogen peroxide (35 wt. % solution in water) was adjusted to pH 7 by addition of the appropriate amount of an aqueous 47 wt. % solution of sodium hydroxide (pH meter control). Distilled water was added to obtain 100 pbw of a sporicide with pH 7. Hydrogen peroxide concentration was 15 wt. %.

### Comparative Example A

### Preparation of a sporicide with pH 9

Example 1 was repeated with the difference that the pH was adjusted to 9.

### Example 2

### Sporicidal Activity Test Against Clostridium difficile Spores

The sporicidal efficacy of the product of Example 1 against dormant spores of Clostridium difficile NCTC 11209 was determined according to European Standard EN 14347:2005, Clauses 4 and 5, adapted for use with Clostridium spores.

80 pbw of the product of Example 1 were mixed with 20 pbw of distilled water containing the spores. No pre-germination was carried out. The initial inoculum level was 3.94×10⁷ spores/ml. Test temperature was 20° C. and contact time was 15 minutes. The decimal log reduction in viable counts was >5.595.

### Example 3

### Sporicidal Activity Test Against Bacillus cereus

The sporicidal efficacy of the product of Example 1 against dormant spores of Bacillus cereus NCIMB 11925 was determined according to method AFNOR NFT 72-230 ‘Water Miscible Neutralisable Antiseptics and Disinfectants used in the liquid state—determining sporicidal action—Dilution-Neutralisation method’. Modifications to the procedure for preparing Bacillus cereus spores & for the test contact time were made accordingly; the medium for preparing the Bacillus inoculum was Oxoid Bacillus cereus selective agar (CM0167) used in conjunction with Oxoid SR099E selective supplement.

90 pbw of the product of Example 1 were mixed with 10 pbw of distilled water containing the spores. No pre-germination was carried out. The initial inoculum level was 1.70×10⁸ spores/ml. Test temperature was 22° C. and contact time was 45 minutes. The decimal log reduction in viable counts was >7.23.

### Comparative Example B

### Sporicidal Activity Test Against Bacillus cereus

Example 3 was repeated with the difference that the product of Comparative Example A was used instead of the product of Example 1. The decimal log reduction in viable counts was >6.46.

Comparing results of Example 3 with Comparative Example B, indicates the lower pH composition prepared according to Example 1 was more effective at the pH 7 (stronger reduction in viable counts). There is also the advantage that the composition of Example 1 can be used on surfaces sensitive to alkaline media in contrast to the composition of Comparative Example A.

What is claimed is:

1. A process for eliminating bacterial spores on a surface comprising contacting the surface with an aqueous composition comprising 3 to 30 wt. % of hydrogen peroxide and having a pH value of 6 to 8, for a period of 1 to 60 minutes at a temperature of 0 to 35° C., wherein the process does not comprise any germination step.

2. The process of claim 1, wherein the aqueous composition comprises 5 to 25 wt. % of hydrogen peroxide.

3. The process of claim 1 or 2, wherein the aqueous composition has a pH value of 6.5 to 7.5.

4. The process of claim 1, wherein the aqueous composition comprises:
3 to 30 wt. % of hydrogen peroxide,
0.05 to 0.5 wt. % of alkali hydroxide,
0.005 to 1 wt. % of at least one transition metal sequestering agent,
0 to 10 wt. % of at least one nonionic surfactant,
0 to 10 wt. % of at least one further auxiliary additive selected from the group consisting of anionic surfactants, amphoteric surfactants, hard water sequestrants, corrosion inhibitors, viscosity modifiers, fragrances and dyes, and
the wt. % proportion remaining is water to make 100 wt. %.

5. The process of claim 4, wherein the aqueous composition comprises at least one auxiliary additive selected from the group consisting of anionic surfactants, amphoteric surfactants, nonionic surfactants, hard water sequestrants, corrosion inhibitors, viscosity modifiers, fragrances, dyes and peroxide decomposition stabilizers.

6. The process of claim 4 wherein the transition metal sequestering agents is selected from the group consisting of dimethylglyoxime, 1,4,7-triazacyclononane, dipyridylamine, ethylenediamine-N,N,N′,N′-tetraacetic acid and its alkali salts, diethylenetriamine-N,N,N′,N′,N″-pentaacetic acid and its alkali salts, nitrilo-2,2′,2″-triacetic acid (NTA) and its alkali salts; 1,2-diaminocyclohexyl tetra(methylene phosphonic acid) and its alkali salts, diethylene triamine penta(methylene phosphonic acid) and its alkali salts, and ethylene diamine tetra(methylene phosphonic acid) and its alkali salts.

7. The process of claim 6, wherein the contact period is 5 to 30 minutes.

8. The process of claim 6, wherein the temperature is 15 to 25° C.

9. The process of claim 1, wherein the surfaces are selected from the group consisting of wood, wood-based materials, plastics, ceramics, glass, concrete, metals and metal alloys.

10. The process of claim 9, wherein the surfaces are of substrates selected from the group consisting of floors, walls, ceilings, tiles, mirrors, windows, doors, door handles, handrails, furniture, equipment, apparatus housings and bed frames.

11. The process of claim 1, wherein the bacterial spores are selected from the group consisting of bacillus subtilis, bacillus cereus, clostridium sporogenes and clostridium difficile.

12. The process of claim 1, wherein the contact between the surfaces and the aqueous composition is made by an application method selected from the group consisting of wipe, brush, dip, rinse and spray application.

13. A sporicide in the form of an aqueous composition comprising 3 to 30 wt. % of hydrogen peroxide,
0.05 to 0.5 wt. % of alkali hydroxide,
0.005 to 1 wt. % of at least one transition metal sequestering agent,
0 to 10 wt. % of at least one nonionic surfactant,
0 to 10 wt. % of at least one further auxiliary additive selected from the group consisting of anionic surfactants, amphoteric surfactants, hard water sequestrants, corrosion inhibitors, viscosity modifiers, fragrances and dyes, and
the wt. % proportion remaining is water to make 100 wt. %;
and having a pH value of 6 to 8.

14. The sporicide of claim 13 comprising 5 to 25 wt. % of hydrogen peroxide.

15. The sporicide of claim 13 or 14, wherein the pH value is 6.5 to 7.5.

16. The sporicide of claim 13 wherein the transition metal sequestering agents is selected from the group consisting of dimethylglyoxime, 1,4,7-triazacyclononane, dipyridylamine, ethylenediamine-N,N,N′,N′-tetraacetic acid and its alkali salts, diethylenetriamine-N,N,N′,N′,N″-pentaacetic acid and its alkali salts, nitrilo-2,2′,2″-triacetic acid and its alkali salts; 1,2-diaminocyclohexyl tetra(methylene phosphonic acid) and its alkali salts, diethylene triamine penta(methylene phosphonic acid) and its alkali salts, and ethylene diamine tetra(methylene phosphonic acid) and its alkali salts.

17. The sporicide of claim 16 comprising at least one auxiliary additive selected from the group consisting of anionic surfactants, amphoteric surfactants, nonionic surfactants, hard water sequestrants, corrosion inhibitors, viscosity modifiers, fragrances, dyes and peroxide decomposition stabilizers.
